(19) United States
(12) Patent Application Publication
(10) Pub. No.: US 2005/0048956 A1
(43) Pub. Date: Mar. 3, 2005

(54) Method and system for providing directions to a mobile phone user

(75) Inventors: Pradeep K. Das, Bethel, CT (US); David W. Spencer, Avon, CT (US)

Correspondence Address: Michael J. Cummings;Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 10/654,339

(22) Filed: Sep. 2, 2003

(51) Int. Cl. H04Q 7/20

(52) U.S. Cl. 455/414.2; 455/456.2

(57) ABSTRACT

A method and system for providing services to a mobile phone user, who needs directions to a desired destination. When the user calls a call center, the call center obtains the location of the mobile phone user from the communications network using a triangulation method. Based on the user's location, the operator at the call center verbally responds to the user with appropriate directions. Advantageously, the service is provided to the brand loyal customers who wish to locate a specific retail establishment such as a gas station or restaurant.

### FIELD OF THE INVENTION

The present invention relates to direction providing services and, more particularly, to providing directions to a mobile phone user.

### BACKGROUND OF THE INVENTION

As a consequence of a very mobile society, travelers often find themselves in unfamiliar locations. In this setting, it is often difficult for a traveler to find specific retail outlets such as restaurants or gas stations. These retail and other commercial interests have a desire to insure that customers remain loyal to their brand while traveling. It is thus advantageous and desirable to provide a method and system to provide direction services to those brand loyal customers so that they can easily locate the specific retail establishment locations.

### SUMMARY OF THE INVENTION

It is a primary object of the present invention to provide a method and system for assisting a traveler in unfamiliar locations in reaching a desired destination. This object can be achieved by automatically determining the location of the traveler if the traveler uses a mobile phone to make an inquiry and determining the location of the desired destination based on the traveler's location.

Accordingly, the first aspect of the present invention is a method of providing directions to a user of a mobile phone who makes an inquiry concerning a destination in a telephone call at a calling location. The method comprises the steps of:
providing at least one call center to process the telephone call;
estimating the calling location of the mobile phone, in response to the inquiry, based on a plurality of reference locations relative to the location of the mobile phone;
determining the direction to the destination based on the estimated location of the mobile phone; and
conveying information to the user indicative of the determined direction.

The second aspect of the present invention is a system for providing directions to a user of a mobile phone who makes an inquiry concerning a destination in a telephone call at a calling location. The system comprises:
at least one call center to process the telephone call;
means, in response to the inquiry, for obtaining the calling location of the mobile phone, based on a plurality of reference locations relative to the location of the mobile phone; and
a software for determining the direction to the destination based on the estimated location of the mobile phone so as to convey information to the user indicative of the determined direction.

The present invention will become apparent reading the description taken in conjunction with FIG. 2.

### BRIEF DESCRIPTION OF THE DRAWINGS

FIG. 1a is a schematic representation illustrating a prior art location calculation using a hyperbolic-type triangulation method.

FIG. 1b is a schematic representation illustrating a prior art location calculation using a circular-type triangulation method.

FIG. 2 is a block diagram showing the system for providing direction services, according to the present invention.

### BEST MODE FOR CARRYING OUT THE INVENTION

The method of providing directions to a traveler who makes an inquiry concerning a destination in a telephone call, according to the present invention, is based on the location of the calling location. In order to provide such a service, it is preferred that one or more call centers are established to receive the telephone call. Advantageously, the call center is capable of knowing where the caller is located so that when the caller informs an operator at the call center of the desired destination location, the caller will be directed to the destination based on the caller's location.

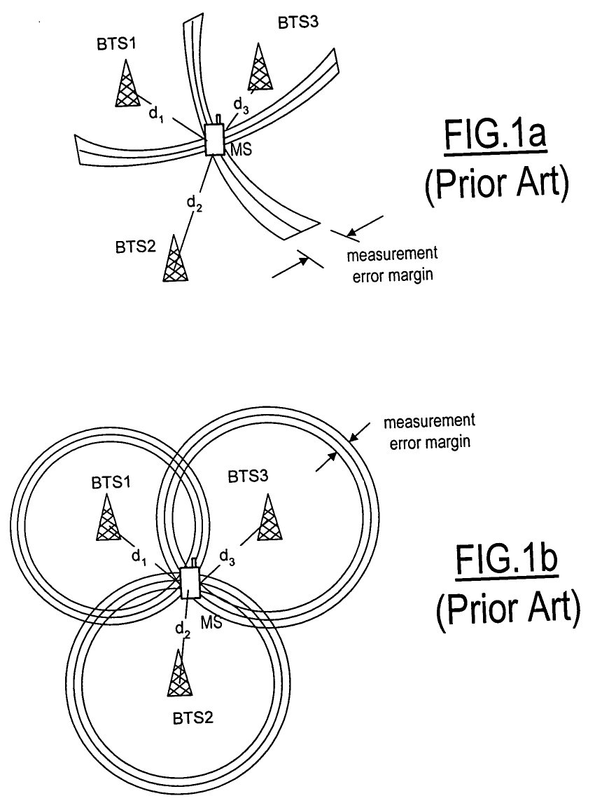

The present invention takes advantage of the fact that the caller can be located if the caller uses a mobile phone. For example, LoCation Services (LCS) is a feature in GSM (Global System for Mobile Communication) standards. GSM standard supports several location estimation technologies including the E-OTD (Enhanced Observed Time Difference) positioning method. The E-OTD method is based on the relative time of arrival of the signals from at least three base stations (BTSs), as shown in FIGS. 1a and 1b. The position of the mobile station (MS) is determined by deducing the geometrical components of the time delays to the mobile station from the base stations. With the measured time delays, a Position Calculation Function (PCF) is used to calculate the location of the mobile station. The PCF can be based on one of two possible types of E-OTD location calculations, known as “hyperbolic” and “circular”. Both calculations are based on the principle of triangulation. The hyperbolic-type E-OTD location calculation is illustrated in FIG. 1a. The circular-type E-OTD location is illustrated in FIG. 1b. The triangulation used in the hyperbolic type is based on the Geometric Time Difference (GTD), or the time difference between the reception by the mobile station of bursts from two base stations due to geometry. The possible location for the mobile station observing a constant GTD value between two base stations is a hyperbola. Thus, the mobile station can be located in the intersection of two hyperbolas obtained from three base stations. The circular-type E-OTD location calculation is based on the individual arrival times, which are substantially proportional to the length of the propagation path between the mobile station and each of the three base stations.

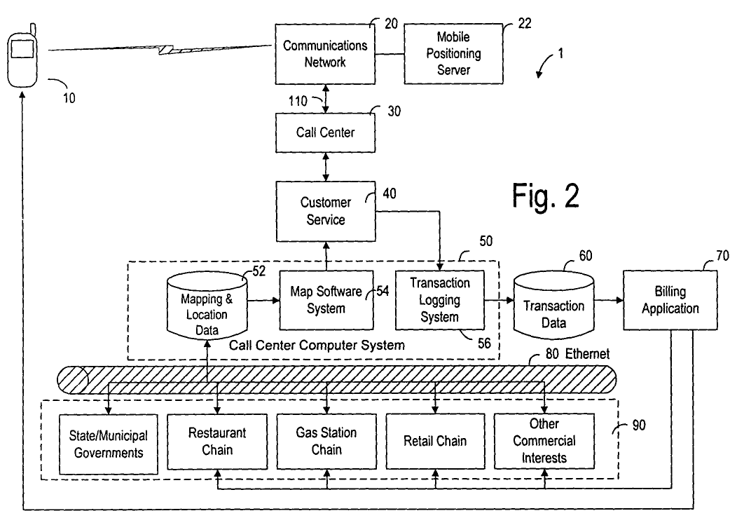

The system 1 for providing direction services, according to the present invention, is shown in FIG. 2. As shown, a caller 10 places a call through the communications network 20 to the call center 30 when the caller 10 inquires the directions to a specific establishment such as a gas station or restaurant. The call center will be established with a highly publicized telephone number to be called by callers looking for directions. The communications network 20 includes a plurality of mobile positioning servers 22, each of which is equipped with a Position Calculation Function to estimate the location of the mobile phone used by the caller 10. At the customer service center 40, a customer service operator receives the call, along with information 110 indicative of the location of caller provided by the communications network 20. This information appears on the operator's computer screen. A computer program 54 in the call center computer system 50 automatically displays a map on the computer screen, pinpointing the actual location of the caller 10. The computer program 54 is linked with mapping location data 52, which contains the street maps, public buildings, and so forth. Preferably, the mapping location data 52 is linked to a databank of addresses. These addresses include those of restaurant chains, gas station chains, retail chains and other commercial interests that have a desire to insure that customers remain loyal to their brand while traveling and are willing to pay a fee to be on the address list. For example, if the caller is an employee of a company that uses specific retail brands (such as hotels, gas stations, etc.) to take advantage of agreements with the company. The system, according to the present invention, provides a mechanism that encourages use of those specific brands. With the known location of the caller 10 and the desired destination verbally informed to the operator by the caller 10, the operator verbally responds to the caller 10 with appropriate directions. Upon termination of the call, the computer program 54 automatically generates a transaction record based on the information provided in the transaction logging system 56. The transaction record is conveyed to the transaction database 60. A billing application software 70 periodically uses the records in the transaction database 60 to generate a bill and send it to the paying party 90. The paying party 90 may be one of (but not limited to) the following:
1. A company of which the traveler may be an employee;
2. The retail establishment to which the directions are directed;
3. A government agency for government employees; and
4. The individual user.
   The actual billing may be accomplished through the normal billing system of the phone network operators.

The caller's destination, may be a retail establishment, which does business at a fixed location for a long period of time. However, the destination may be a location for a short-term event, such as a concert, a country fair, a flower show or the like. Thus, although the invention has been described with respect to a preferred embodiment thereof, it will be understood by those skilled in the art that the foregoing and various other changes, omissions and deviations in the form and detail thereof may be made without departing from the scope of this invention.

1. A method of providing directions to a user of a mobile phone who makes an inquiry concerning a destination in a telephone call at a calling location, said method comprising the steps of:
providing at least one call center to process the telephone call;
estimating the calling location of the mobile phone, in response to the inquiry, based on a plurality of reference locations relative to the calling location of the mobile phone;
determining the direction to the destination based on the estimated location of the mobile phone; and
conveying information to the user indicative of the determined direction.

2. The method of claim 1, wherein the estimating step is carried out using a triangulation method.

3. The method of claim 1, wherein the information is conveyed to the user verbally.

4. The method of claim 1, wherein the direction is determined based on a mapping location database.

5. A system for providing directions to a user of a mobile phone who makes an inquiry concerning a destination in a telephone call at a calling location, said system comprising:
at least one call center to process the telephone call;
means, in response to the inquiry, for obtaining the calling location of the mobile phone, based on a plurality of reference locations relative to the location of the mobile phone; and
a software for determining the direction to the destination based on the estimated location of the mobile phone so as to convey information to the user indicative of the determined direction.
